(19) United States
(12) Patent Application Publication
(10) Pub. No.: US 2016/0188265 A1
(43) Pub. Date: Jun. 30, 2016

(54) Local newspaper printer

(71) Applicant: Michael Lewis Moravitz, Fairfax, VA (US)

(72) Inventor: Michael Lewis Moravitz, Fairfax, VA (US)

(21) Appl. No.: 14/998,893

(22) Filed: Mar. 1, 2016

(51) Int. Cl. G06F 3/12

(52) U.S. Cl. CPC G06F 3/1205; G06F 3/1237

(57) ABSTRACT

A local printer for newspapers—and perhaps magazines—for subscription service that would print out the publications in their traditional forms.

Some corporations, such as Yahoo, Google, and Twitter, are offering customized publications through personalization and on-demand printing.

This would increase subscription fees to publications, such as newspapers, magazines, etc. However, many people may want their newspaper or other publication in a traditional form. Businesses, such as hotels, restaurants, coffee shops, and other gathering places, may find the local newspaper printer their best option for providing not only a local paper, but some regional, national, and international ones as well—depending on the businesses' needs and the costs involved. This technology may even one day come to homes: many people like to read newspapers in their traditional forms and not just online or in a legal paper format. There may be innovations that make this more likely—and in different formats than I am describing. A newspaper that prints out at a home or business—for subscription fees—may be the future for many publications. The publications can be linked to laptops, Ereaders and other devices through businesses and personal subscriptions for reading online if a customer does not wish to have a print out on the local newspaper printer. Even magazines and other journals may one day be printed out locally by businesses such as bookstores and other proprietors and at home. To print out the newspaper in the broadsheet or tabloid form—with an appropriate paper for printing out—would be the main technological problem to solve, in my opinion, in this idea. The printer might have multiple trays for different types of publications and their types of paper and forms; perhaps one for broadsheet, one for tabloid, and one for magazine/journal. The online technologies to access, select, pay of, and to set this system up overall already exist, and it can build on prior customization and personalization efforts and on-demand printing initiatives by the Internet industry.

1) Builds on patents for local printers;

2) Personalized and on-demand technologies by MyYahoo, I-Google, CRAYON, ICurrent.com, Kibboko.com, Twitter.times, etc.

3) Standard newspaper printers for tabloids and broadsheets.
